(19) United States
(12) Patent Application Publication
(10) Pub. No.: US 2009/0015966 A1
(43) Pub. Date: Jan. 15, 2009

(54) MAGNETIC DISK APPARATUS

(75) Inventor: Takuya Kobayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/233,217

(22) Filed: Sep. 18, 2008

Related U.S. Application Data
(63) Continuation of application No. PCT/JP2006/306552, filed on Mar. 29, 2006.

(51) Int. Cl. G11B 5/127; G11B 5/82

(52) U.S. Cl. 360/110; 360/135; G9B/5.04

(57) ABSTRACT

There is disclosed a magnetic disk apparatus including a magnetic disk and a magnetic head for recording data onto the magnetic disk or reading data from the magnetic disk. The magnetic disk includes a retracting part for loading the magnetic head on a surface of the magnetic disk or unloading the magnetic head from the surface of the magnetic disk. The magnetic head includes a protruding part provided at a tip part thereof. The retracting part includes an engaging part extending above the magnetic disk and having a slope part, and a driving part configured to move the engaging part in a direction orthogonal to the surface of the magnetic disk in a state where the protruding part contacts the slope part when unloading the magnetic head from the surface of the magnetic disk.

### CROSS-REFERENCE TO RELATED APPLICATION

This application is a U.S. continuation application filed under 35 USC 111(a) claiming benefit under 35 USC 120 and 365(c) of PCT application JP2006/306552, filed Mar. 29, 2006. The foregoing application is hereby incorporated herein by reference.

### BACKGROUND OF THE INVENTION

1. Field of the Invention

The present invention generally relates to a ramp load/unload type magnetic disk apparatus.

2. Description of the Related Art

In recent years and continuing, the acceleration of communication technology has significantly increased the amount of data being handled. Accordingly, magnetic disk apparatuses, particularly hard disk apparatuses are becoming more widely used. Magnetic disk apparatuses have large storage capacity, high recording density, and high speed accessibility. In addition, magnetic disk apparatuses are small sized and light weight, to thereby enable the magnetic disk apparatuses to be mounted in portable devices such as notebook type personal computers, portable audio players, and mobile phones.

A magnetic disk apparatus according to a related art example has a housing in which a magnetic head for recording and reproducing data and a magnetic disk for storing data are installed.

Size reduction of the magnetic head and the magnetic disk has been promoted along with the size reduction of the magnetic disk apparatus. Furthermore, for the purpose of improving shock-resistance and smoothing the surface of the magnetic disk, a ramp load/unload method may be used for retracting the magnetic head from the area where the magnetic disk is located (magnetic disk area) when the magnetic disk apparatus is in a non-operating state.

FIGS. 1A-1C are cross-sectional views for describing an unloading operation when using a ramp load/unload method. As depicted in FIG. 1A, a magnetic head 101 “floats” above a magnetic disk 102 when data are being recorded onto or reproduced from the magnetic disk 102 (illustrated as S1 in FIG. 1A). The magnetic head 101 has a recording/reproduction device 104 provided on a surface (medium-facing surface) 103a of a head slider 103. By rotating the magnetic disk 102, an air bearing is created between the medium facing surface 103a and a surface of the magnetic disk 102. The air bearing generates negative pressure and positive pressure corresponding to fine protrusions and recesses formed on the medium facing surface 103a and stabilizes the floating amount of the head slider 103.

A beam-like lift tab 105 is provided at a tip part of the magnetic head 101. The lift tab 105 and the head slider 103 are resiliently coupled together by, for example, a plate spring. When unloading the magnetic head 101, the lift tab 105 contacts a slope part 106a of a ramp 106 as the magnetic head 101 moves toward the outer periphery of the magnetic disk 102 (illustrated as S2 in FIG. 1A). As depicted in FIG. 1B, the slope part 106a pulls the lift tab 105 upward as the magnetic head 101 is moved towards the outer periphery of the magnetic disk 102 (illustrated as S3 in FIG. 1B). However, since force is applied to the medium facing surface 103a by the air bearing, the head slider 103 floats with a floating amount greater than its regular floating state until the head slider 103 is pulled up with a certain amount of force.

As depicted in FIG. 1C, the lift tab 105 is further pulled upward by the slope part 106a as the magnetic head 101 moves further toward the outer periphery of the magnetic disk 102. The air bearing diminishes as the lift tab 105 is pulled upward with an even greater force by the slope part 106a (illustrated as S4 in FIG. 1C). The magnetic head 101 further moves toward the outer periphery of the magnetic disk 102 until reaching an area beyond the magnetic disk area (retracted state) as illustrated as S5 in FIG. 1C. The unloading operation is completed when the magnetic head 101 makes the transition from the floating state to the retracted state.

As depicted in FIGS. 1A-1C, since the transition from the floating state to the retracted state by the slope part 106a of the ramp 106 during the unloading operation causes the floating amount of the magnetic head 101 to change from its regular amount, the magnetic head 101 tends to be unstable. Therefore, a portion of the magnetic disk area corresponding to an area starting from a point where the lift tab 105 contacts the slope part 106a to a point where the air bearing diminishes (illustrated as D1 in FIG. 1C) cannot be used for reproducing from or recording data onto the magnetic disk 102.

Furthermore, it is difficult to attain assuring surface characteristics (e.g., shape, protrusions/recesses) at an area extending from an outer peripheral rim part to a predetermined inner peripheral part of the magnetic disk 102 (illustrated as D2 in FIG. 1C). Accordingly, the area including portions D1 and D2 cannot be used as an area for reproducing or recording data to the magnetic disk 102 (unusable area). Since the outer peripheral part of the magnetic disk 102 has a greater length than the inner periphery part of the magnetic disk 102, the unusable area covers a relatively large portion of the surface of the magnetic disk 102. The influence of the unusable area with respect to storage capacity becomes greater as the magnetic disk 102 is manufactured with a smaller diameter. This makes it difficult to maintain or increase storage capacity while reducing the diameter of the magnetic disk 102.

### SUMMARY OF THE INVENTION

It is a general object of the present invention to provide a magnetic disk apparatus that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a magnetic disk apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a magnetic disk apparatus including a magnetic disk and a magnetic head for recording data onto the magnetic disk or reading data from the magnetic disk, having: a retracting part for loading the magnetic head on a surface of the magnetic disk or unloading the magnetic head from the surface of the magnetic disk; wherein the magnetic head includes a protruding part provided at a tip part thereof, wherein the retracting part includes an engaging part extending above the magnetic disk and having a slope part, and a driving part configured to move the engaging part in a direction orthogonal to the surface of the magnetic disk in a state where the protruding part contacts the slope part when unloading the magnetic head from the surface of the magnetic disk.

Other objects and further features of the present invention will be apparent from the following detailed description when read in conjunction with the accompanying drawings.

### BRIEF DESCRIPTION OF THE DRAWINGS

FIGS. 1A-1C are schematic diagrams for describing problems with a magnetic disk apparatus according to a related art example;

FIG. 2 is a plan view illustrating a portion of a magnetic disk apparatus according to an embodiment of the present invention;

FIG. 3 is a block diagram illustrating a configuration of a magnetic disk apparatus according to an embodiment of the present invention;

FIG. 4 is a side view depicting the vicinity of a ramp according to an embodiment of the present invention;

FIGS. 5A-5C are schematic diagrams for describing movement of a ramp during an unloading operation according to an embodiment of the present invention; and

FIG. 6 is a side view depicting the vicinity of a ramp according to an embodiment of the present invention.

### DESCRIPTION OF THE PREFERRED EMBODIMENTS

In the following, embodiments of the present invention are described with reference to the accompanying drawings.

### First Embodiment

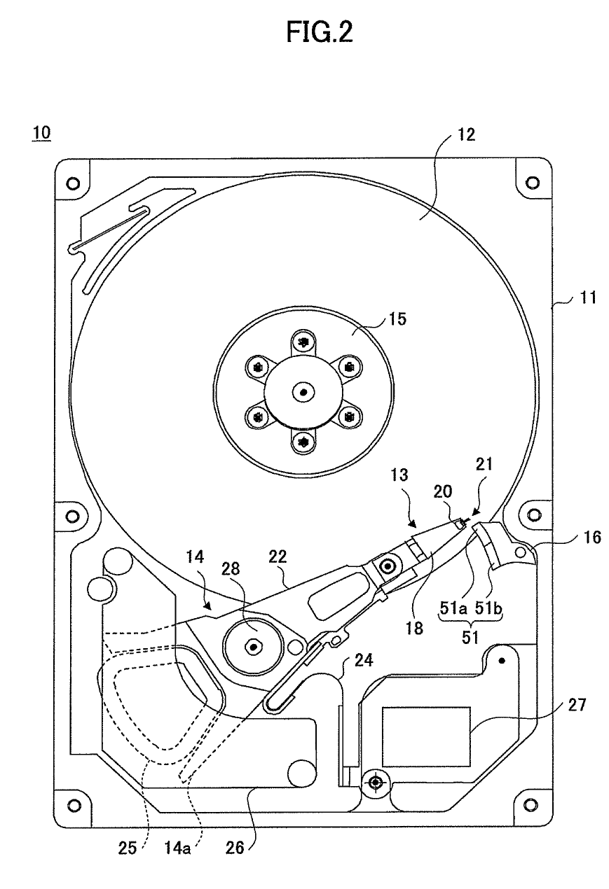

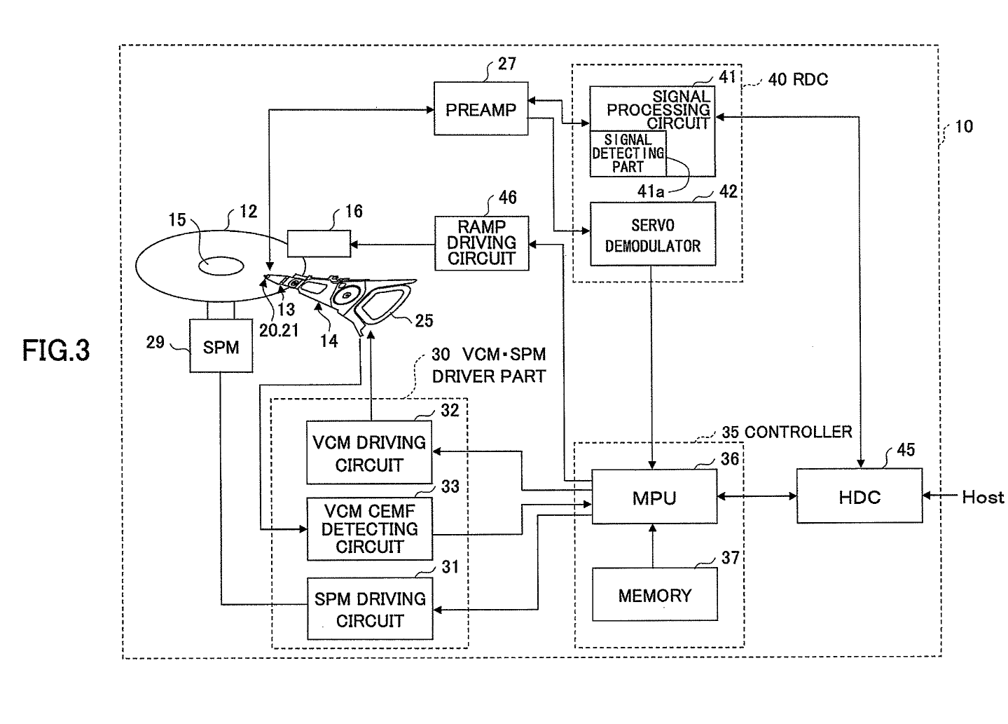

FIG. 2 is a plan view illustrating a portion of a magnetic disk apparatus 10 according to an embodiment of the present invention. FIG. 2 illustrates the magnetic disk apparatus 10 having its cover removed. FIG. 3 is a block diagram illustrating a configuration of the magnetic disk apparatus 10 according to an embodiment of the present invention.

With reference to FIGS. 2 and 3, the magnetic disk apparatus 10 includes, for example, a housing 11 and a magnetic disk 12, a magnetic head 13, an actuator unit 14, a hub 15, and a ramp 16 that are installed in the housing 11. The magnetic disk apparatus 10 also includes a spindle motor (SPM) 29 for rotating the magnetic disk 12. The spindle motor cannot be seen in FIG. 2 since it is positioned underneath the magnetic disk 12 and the hub 15. The magnetic disk apparatus 10 has signals input to and output from the magnetic head 13 via an FPC (Flexible Printed Circuit) 24. The FPC 24 is connected to a preamplifier (preamp) 27. The FPC 24 is also connected to a printed circuit board (not illustrated) mounted on a side of the housing 11 opposite to the magnetic disk 12. The printed circuit board includes, for example, a VCM•SPM driver part 30, a controller 35, a read/write channel circuit part (RDC) 40, a hard disk controller (HDC) 45, and a ramp driving circuit 46.

The magnetic disk 12 has a recording layer (not illustrated), which is made of a ferromagnetic material, formed on a disk-shaped substrate. The magnetic disk 12 may be an in-plane magnetic recording medium or a perpendicular magnetic recording medium. The magnetic disk 12 may also be an oblique anisotropic magnetic recording medium having an easy axis oriented at an oblique angle with respect to the surface of the substrate. The magnetic disk 12 is fixed into place by inserting a shaft (not illustrated) of a rotor (not illustrated) of the spindle motor 29 through a center hole of the magnetic disk 12 and pressing hub 15 against the magnetic disk 12. It is, however, to be noted that the configuration of the magnetic disk 12 is not limited to the one illustrated in FIGS. 2 and 3.

For example, the magnetic disk apparatus 10 may have a single magnetic disk 12 or plural magnetic disks 12 that are separated from each other in a vertical direction.

The SPM 26 rotates the magnetic disk 12 at a high speed in a predetermined direction by supplying an SPM drive current from an SPM drive circuit of the SPM driver part 30.

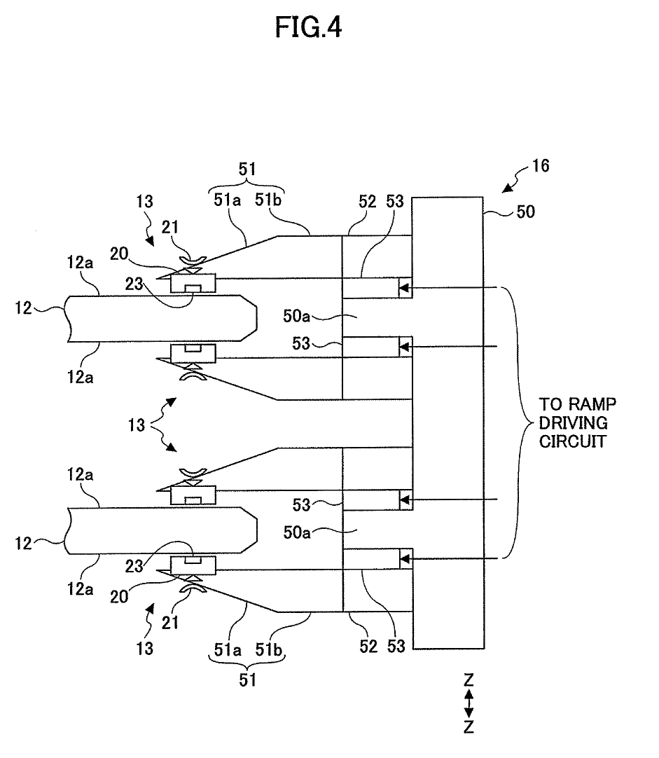

The magnetic head 13 has a head slider 20 provided at a tip part of a suspension 18 (e.g., plate spring) toward the side facing the magnetic disk 12. The head slider 20 has a device part (too small to be illustrated in FIG. 2 but indicated with reference numeral 23 in FIG. 4) including a recording device and a reproducing device. The magnetic head 13 has a cantilever lift tab 21 provided at a tip part of the suspension 18. The lift tab 21 and the head slider 20 are resiliently coupled together by the suspension 18, for example.

The magnetic head 13 has its base part supported by an actuator (actuator unit) 14 via an arm 22. The actuator 14 rotates the magnetic head 13 in a radial direction of the magnetic disk 12. A single magnetic head 13 may be provided in correspondence with each magnetic disk 12 or in correspondence with each surface of the magnetic disk 12.

In a case of recording data onto the magnetic disk 12 with the magnetic head 13, the magnetic head 13 receives recording currents supplied from the preamp 27 and generates a recording magnetic field with the recording device of the device part 23, to thereby record data onto the magnetic disk 12. The recording currents are recording signals (write data signals encoded with a predetermined encoding method) that are supplied from the HDC 45 via a signal processing circuit 41 and encoded by the preamp 27.

In a case of reproducing data from the magnetic disk 12 with the magnetic head 13, the magnetic head 13 reads out track data, user data, and servo data recorded in the magnetic disk 12, converts the data to electric signals (reproduction signals), and outputs the reproduction signals to the preamp 27. The preamp 27 amplifies the reproduction signals and sends the amplified reproduction signals to the signal processing circuit 41 and a servo demodulator (servo demodulating circuit) 42. The signal processing circuit 41 demodulates the reproduction signals to read data signals and sends the read data signals to the HDC 45. The signal processing circuit 41 includes a signal detecting part 41a (described below) for detecting signal voltage of reproduction signals. Furthermore, the servo demodulator 42 demodulates servo signals to head position signals indicative of the position of the magnetic head 13 and sends the head position signals to an MPU 36 of the controller 35.

The actuator 14 has a voice coil motor (VCM) 25 provided at its base part 14a. The VCM receives a driving current from a VCM driving circuit 32 and generates a reactive force with respect to a magnetic field of permanent magnets 26 positioned above and below the VCM, to thereby rotate the magnetic head 13 with a rotary axle 28 as its center. The magnetic head 13 also receives a driving current from the VCM driving circuit 32 for seeking a given track (seek operation) or performing a loading/unloading operation.

When the magnetic head 13 performs seeking, the VCM 25 generates a counter-electromotive force proportional to the seeking speed of the magnetic head 13. A VCM counter electromotive force 36 detects the size of the counter-electromotive force of the VCM 26, and sends the size of the counter-electromotive force in the form of a digital data signal to the MPU 36 of the controller 35. The MPU 36 uses a program stored in a memory 37 of the controller 35 for performing a function of, for example, controlling the seeking speed of the magnetic head 13, estimating the position of the magnetic head 13 during the seeking operation or calculating the moving distance of the magnetic head 13 during the seeking operation. These functions are used when determining the timing for driving a driving part 53 of the ramp 16 during an unloading operation (described below). The MPU 36 sends control signals to, for example, the VCM driving circuit 32 or the ramp driving circuit 46 for controlling the seek operation of the magnetic head 13 or the movement of the driving part 53 of the ramp 16.

The ramp 16 is located substantially outside a magnetic disk area (the area where the magnetic disk 12 is positioned and the space above and below the area) in a manner where a slope part 51a of its engaging part 51 (described below) projects toward the magnetic disk area. The ramp 16 is provided on a trajectory on which the lift tab 21 travels along with the rotation of the actuator 14. The ramp 16 has a function of separating the magnetic head 13 from a surface (magnetic disk surface) 12a of the magnetic disk 12 by pulling the lift tab 21 upward when unloading the magnetic head 13 out of the magnetic disk area. The ramp 16 also has a function of creating a floating state of the magnetic head 13 by positioning the head slider 20 close above the magnetic disk surface 12a when loading the magnetic head 13 close to the magnetic disk 12.

FIG. 4 is a side view depicting the vicinity of the ramp 16 according to the first embodiment of the present invention. Although FIG. 4 illustrates four magnetic heads 13 for recording data onto or reproducing data from each side (surface) of two magnetic disks 12, the present invention is not limited to this configuration illustrated in FIG. 4.

In FIG. 4, the ramp 16 includes, for example, a ramp body part 50, an engaging part 51 for raising and lowering the lift tab 21 of each magnetic head 13 with respect to the magnetic disk surface 12a, a movable part 52 for connecting the engaging part 51 and the ramp body part 50 together, and the driving part 53 for moving the engaging part 51 in a direction orthogonal to the magnetic disk surface 12a.

The engaging part 51 includes the slope part 51a projecting toward the magnetic disk area and a substantially flat retracting part 51b continuing from the slope part 51a. The engaging part 51 is configured to unload the head slider 20 by moving away from the magnetic disk surface 12a in the Z-axis direction while contacting the lift tab 21 of the magnetic head 13. The driving part 53 is configured to extend/contract in the Z-axis direction. The driving part 53 may be formed of a piezoelectric ceramic element using a piezoelectric ceramic of, for example, Pb (Zr, Ti)O₃(PZT) or (Pb, La) (Zr, To)O₃(PLZT). The piezoelectric element may be a single plate type having a plate of a piezoelectric ceramic crystal sandwiched by two electrodes or a layered type having alternate layers of a piezoelectric ceramic layer and an electrode layer. The piezoelectric element is suitable for the driving part 53 as the piezoelectric element is capable of responding at high speed.

The driving part 53 has one side (side orthogonal with respect to the Z-axis direction) fixed to and supported by a projecting part 50 of the ramp body part 50. The driving part 53 has another plane (another side orthogonal with respect to the Z-axis direction) fixed to the movable part 52.

The configuration of the movable part 52 is not to be limited as long as the engaging part 51 can be moved in the Z-axis direction. The movable part 52 may be a flexible resin member or a flexible metal member (e.g., plate spring) from the aspect of easily forming the movable part 52 in a small size. In this case, the movable part 52 is bent by the force applied from the driving part 53 so that the slope part 51a of the engaging part 51 moves away from the magnetic disk surface 12a in the Z-axis direction.

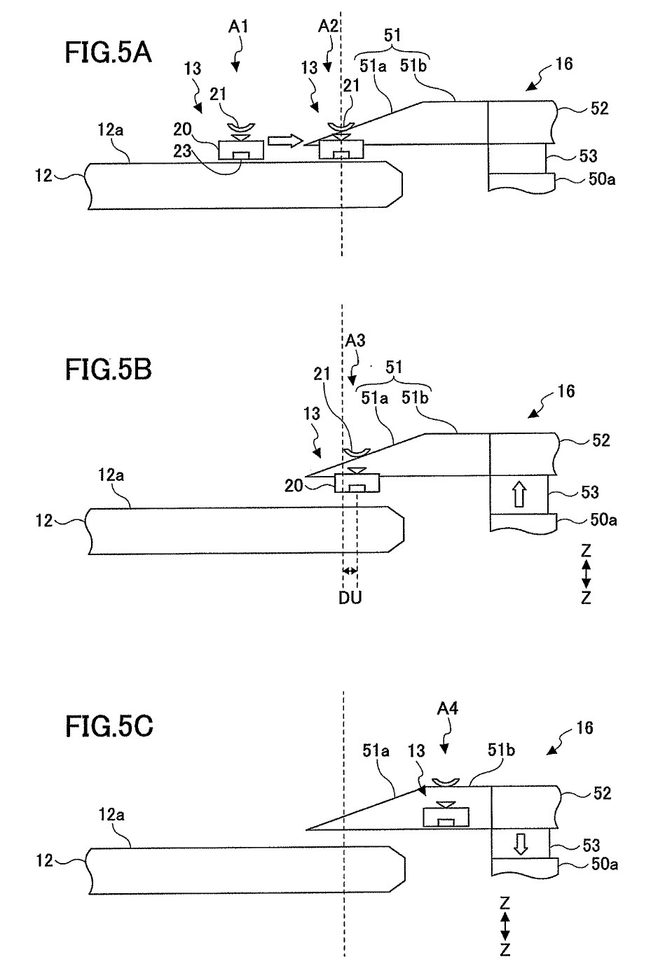

Next, an unloading operation according to an embodiment of the present invention is described with reference to FIGS. 3 and 5A-5C. FIGS. 5A-5C are schematic diagrams for describing movement of the ramp 16 during an unloading operation according to an embodiment of the present invention. In FIG. 5A-5C, the unloading operation is illustrated in chronological order from FIG. 5A to FIG. 5C. The position of the magnetic head 13 is indicated with reference numerals A1-A5. For the sake of convenience, a partial configuration of the ramp 16 corresponding to one side of the magnetic disk 12 is illustrated in FIG. 5A-5C.

In FIG. 5A, the VCM 25, in accordance with an unload instruction, initiates the unloading operation of the magnetic head 13 by driving the magnetic head 13 to move toward the outer periphery of the magnetic disk 12. The unload instruction is dispatched from the HDC 45 and sent to the MPU 36. Then, the MPU, in accordance with the unload instruction, sends a control signal to the VCM driving circuit 32. Accordingly, the VCM, in accordance with a driving current from the VCM driving circuit 32, moves the magnetic head 13 toward the outer periphery of the magnetic disk 12, so that the lift tab 21 of the magnetic head 13 contacts the slope part 51a of the engaging part 51 (illustrated as A2 in FIG. 5A).

Then, in FIG. 5B, immediately after the lift tab 21 contacts the slope part 51a, a driving voltage signal is supplied from the ramp driving signal circuit 46 to the ramp 16 for extending the driving part 53 in the z-axis direction (upward direction in FIG. 5B). In correspondence with the movement of the driving part 53, the engaging part 51a is separated from the magnetic disk surface 12a in the z-axis direction (upward direction in FIG. 5B). Thereby, the air bearing created between the magnetic head 13 and the magnetic disk surface 12a diminishes, and the magnetic disk 13 shifts from a floating state to a retracted state (illustrated as A3 in FIG. 5B). By moving the driving part 53 immediately after the lift tab 21 contacts the slope part 51a, a separating force can be smoothly applied to the lift tab 21.

The timing for supplying the driving voltage signal is not limited to immediately after the lift tab 21 contacts the slope part 51a. For example, the timing for supplying the driving voltage signal may be supplied substantially at the same time when the lift tab 21 contacts the slope part 51a. This is effective in a case where the response time (time for the driving part 53 to move after the driving voltage signal is supplied) is not small enough (e.g., greater than 1/10) with respect to the time for the lift tab 21 to climb up the slope part 51a after contacting the slope part 51a.

The timing for supplying the driving voltage signal may be determined as follows. First, the MPU 36, using a program stored in the memory 37, calculates the distance between the position of the magnetic head 13 at the time when the unload instruction is dispatched (A1 in FIG. 5B) and the position (contact position) of the magnetic head 13 at the time when the lift tab 21 will contact the slope part 51a (A2 in FIG. 5B). Then, the MPU 36, based on the calculated distance and seeking speed of the magnetic head 13, calculates the time from when a seeking operation for unloading is started to when the lift tab 21 will contact the slope part 51a. Then, by estimating the time when the lift tab 21 contacts the slope part 51a based on the calculated time, the MPU determines the timing for supplying the driving voltage signal. The position A1 of the magnetic head 13 may be obtained according to a track number. The track number is included in track data recorded in the magnetic disk 12. Accordingly, the magnetic head reproduces the track data and sends data including the track number to the MPU 36 via the signal processing circuit 41 and the HDC 45.

Data of contact positions obtained beforehand are stored in the memory 37. When the lift tab 21 contacts the slope part 51a, the voltage of reproduction outputs (outputs reproducing servo data, track data, or user data recorded in the magnetic disk 13) obtained by the seeking operation decreases. The signal detecting part 41a of the signal processing circuit 41 is configured to detect changes of the reproduction output voltage where the magnetic head 13 begins a seeking operation from a position corresponding to a predetermined track (reference position). For example, timing of the lift tab 21 contacting the slope part 51a can be detected when the signal detecting part 41a detects that the voltage of a reproduction signal of servo data has decreased a predetermined proportion with respect to that during the seeking operation. Along with detecting the timing of the contact between the lift tab 21 and the slope part 51a, a VCM counter-electromotive force detecting circuit 33 calculates the moving distance of the magnetic head 13 by integrating counter-electromotive force detected from the time of starting the seeking operation to the time of the contact between the lift tab 21 and the slope part 51a. Thereby, data of the contact position based on the distance from the reference position can be obtained.

Alternatively, the contact position may be determined by performing the unloading operation beforehand, reading out track data during seeking in the unloading operation, and obtaining a track number of the track data read out immediately before the lift tab 21 contacts the slope part 51a. In this case, the track number of the contact position is determined by estimating the difference of the track number obtained immediately before the lift tab 21 contacts the slope part 51a and the actual track number when the lift tab 21 contacts the slope part 51a and correcting the track number obtained immediately before the lift tab 21 contacts the slope part 51a based on the estimated difference.

Then, in FIG. 5C, as the magnetic head 13 moves further toward the outer periphery of the magnetic disk 12, the lift tab 21 moves the retracting part 51b. The moving of the magnetic head 13 is stopped when the magnetic head 13 is positioned substantially outside of the magnetic disk area, that is, not above the surface of the magnetic disk 12 (A4 in FIG. 5C). Then, the extended driving part 53 contracts to its initial position (as illustrated by an arrow in FIG. 5C) by stopping the supply of drive voltage signals to the driving part 53. Thereby, the engaging part 51 is moved back to its starting position of the unloading operation (unloading start position).

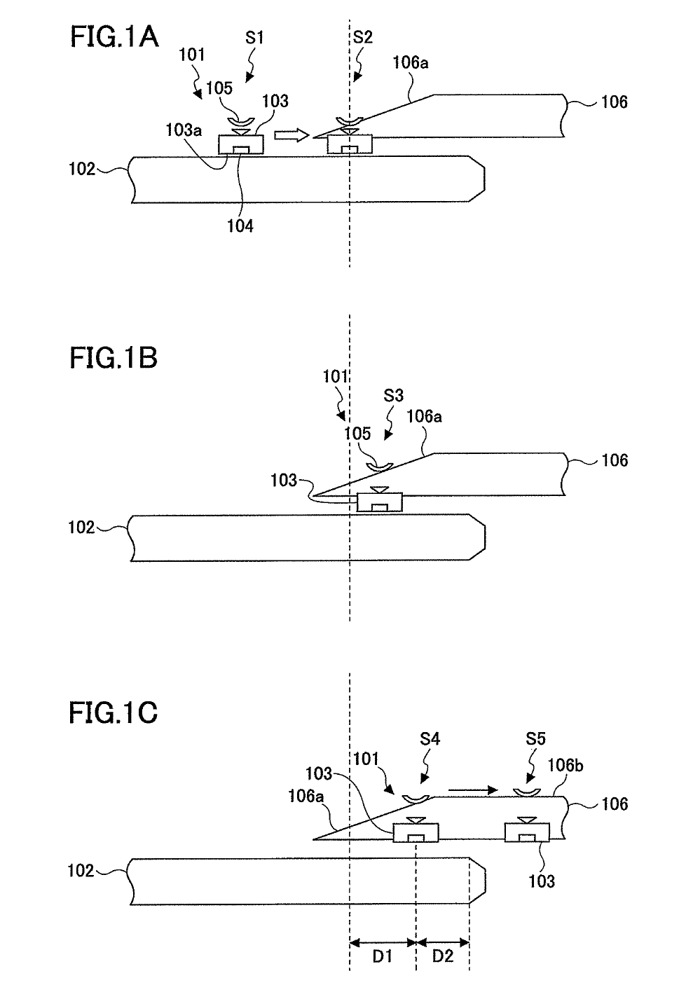

According to the above-described embodiment of the present invention, the driving part 53 effectively moves the lift tab 21 contacting the slope part 51a substantially in the z-axis direction and away from the magnetic disk surface 12a. Thereby, the distance DU (moving distance of the magnetic head 13 between position A2 and position A3 as shown in FIG. 5A and FIG. 5B) for separating the head slider 20 from the magnetic disk surface 12a can be significantly reduced compared to the related art example shown in FIGS. 1A-1C. As a result, the area in the magnetic disk area which cannot be used for reproducing data from or recording data onto the magnetic disk 12 (unusable area) can be reduced. To this extent, more magnetic disk area can be used for reproducing from or recording data onto the magnetic disk 12. It is preferable to apply the above-described embodiment of the present invention to a magnetic disk apparatus including a magnetic disk having a size of 1.8 inches, 1 inch, or less than 1 inch.

Since the positional relationship between the magnetic disk surface 12a and the engaging part 51 during the state shown in FIG. 5C is the same as that during the state shown in FIG. 5A when performing a loading operation, the magnetic head 13 can be moved toward the inner periphery of the magnetic disk 12 at seeking speed without having to move the engaging part 51 from the retracted state (A4). Accordingly, the magnetic head 13 can be easily controlled during the loading operation. Thus, the loading operation can be conducted more reliably.

In an unloading operation of the magnetic head 13 according to the above-described embodiment of the present invention, the driving part 53 extends in a direction separating from the magnetic disk surface 12a while the lift tab 21 of the magnetic head 13 is in contact with the slope part 51a of the engaging part 51 of the ramp 16. Accordingly, the engaging part 13 is moved in a direction separating from the magnetic disk surface 12a and the magnetic head 13 is separated from the magnetic disk surface 12a. Thereby, the distance for separating the magnetic disk surface 12a from the magnetic head 13 can be shortened. The shortening of the distance increases the area of the magnetic disk 12 that can be used for recording/reproducing data to/from the magnetic disk 12. Hence, the storage capacity of the magnetic disk apparatus 10 can be increased.

### Second Embodiment

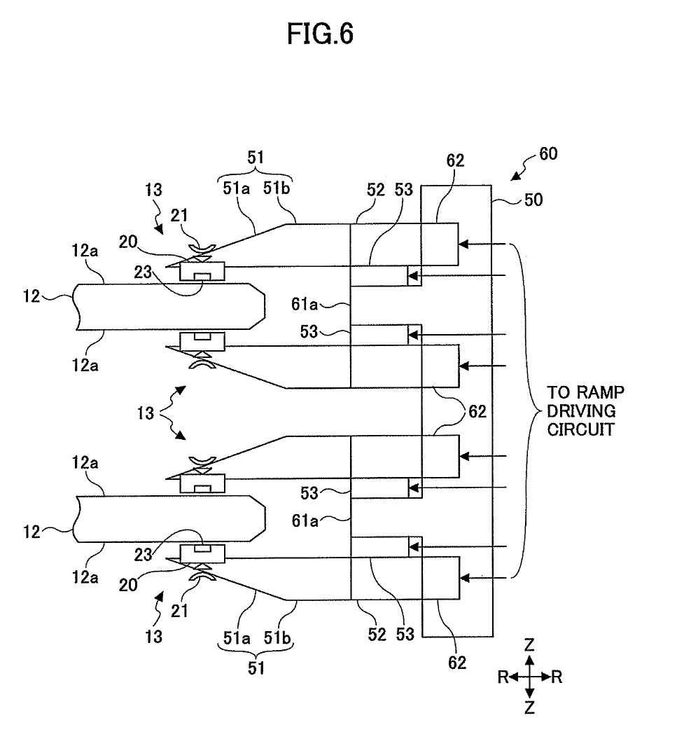

The below-described magnetic disk apparatus according to a second embodiment of the present invention has substantially the same configuration as the magnetic disk apparatus 10 according to the first embodiment of the present invention shown in FIGS. 2 and 3 except for the configuration of the below-described ramp 60. Therefore, the magnetic disk apparatus according to the second embodiment of the present invention is described with FIG. 6 together with FIGS. 2 and 3.

FIG. 6 is a side view depicting the vicinity of the ramp 60 according to the second embodiment of the present invention.

In FIG. 6, in addition to the ramp body part 50, the engaging part 51, the movable part 52 and the driving part 53, the ramp 60 includes a positioning part 62 for defining the position in which the engaging part 51 projects from the ramp body part 50 toward the magnetic disk area. The positioning part 62 is configured to move and maintain the position of the engaging part 51 with respect to a direction in which the engaging part 51 projects to the magnetic disk area (R axis direction) that is, substantially the radial direction of the magnetic disk 12. The same as the driving part 53, the positioning part 62 may also be formed of a piezoelectric ceramic element. The positioning part 62 receives positioning signals from the ramp driving circuit 46 indicating the amount the engaging part 51 is to be moved.

In the embodiment of the present invention shown in FIG. 6, since four engaging parts 51 are positioned by the positioning part 62, the contacting positions of the slope parts 51a of the engaging parts 51 can be precisely matched with corresponding lift tabs 21 of the four magnetic heads 13.

According to a related art example, the contact positions between four lift tabs and corresponding slope parts are to be located at a part of a ramp closest to the inner peripheral part of a magnetic disk with respect to the radial direction of the magnetic disk. The contact positions are to be set closest to the inner peripheral part of the magnetic disk also due to factors such as inconsistency in the shapes of the ramps, assembly error of the ramps, or error of the shapes of the magnetic head. These restricted contact positions increase the size of the unusable area of the magnetic disk. The increase in the size of the unusable area results in reduction of storage space.

However, with the above-described second embodiment of the present invention, because the engaging parts 51 can be arbitrarily positioned and the contact positions can be determined (detected) based on the magnetic head 13 that is actually being used, the contact positions can be set more toward the outer peripheral part of the magnetic disk 12 compared to the related art example. Therefore, even with a configuration having plural magnetic heads 13 or plural magnetic disks 12, each engaging part 51 can be arbitrarily positioned at a desired position. Therefore, the unusable area can be reduced compared to the related art example. Accordingly, not only can the second embodiment of the present invention attain the advantages of the first embodiment of the present invention, the second embodiment of the present invention can increase recording/reproduction capacity by increasing the usable area for recording/reproducing data from a magnetic disk.

Further, the present invention is not limited to these embodiments, but variations and modifications may be made without departing from the scope of the present invention.

What is claimed is:

1. A magnetic disk apparatus including a magnetic disk and a magnetic head for recording data onto the magnetic disk or reading data from the magnetic disk, comprising:
a retracting part for loading the magnetic head on a surface of the magnetic disk or unloading the magnetic head from the surface of the magnetic disk;
wherein the magnetic head includes a protruding part provided at a tip part thereof,
wherein the retracting part includes
an engaging part extending above the magnetic disk and having a slope part, and
a driving part configured to move the engaging part in a direction orthogonal to the surface of the magnetic disk in a state where the protruding part contacts the slope part when unloading the magnetic head from the surface of the magnetic disk.

2. The magnetic disk apparatus as claimed in claim 1, wherein the driving part is configured to move the engaging part away from the surface of the magnetic disk after the protruding part contacts the slope part.

3. The magnetic disk apparatus as claimed in claim 1, wherein the driving part is formed of a piezoelectric element, wherein the driving part is configured to extend in a direction where the engaging part moves away from the surface of the magnetic disk according to a driving voltage signal.

4. The magnetic disk apparatus as claimed in claim 1, wherein the driving part moves the engaging part back to an unloading start position after the magnetic head is moved to an area not above the surface of the magnetic disk.

5. The magnetic disk apparatus as claimed in claim 1, further comprising:
a contact position detecting part configured to detect a contact position according to a reproduction signal obtained from the magnetic disk by the magnetic head, the contact position being the position where the protruding part contacts the slope part; and
a contact time estimating part configured to estimate a time when the protruding part contacts the slope part from the start of the unloading of the magnetic head according to the position of the magnetic head at the start of the unloading of the magnetic head and the contact position detected by the contact position detecting part beforehand;
wherein the driving part is configured to move according to the time estimated by the contact time estimating part.

6. The magnetic disk apparatus as claimed in claim 1, wherein the retracting part includes a positioning part configured to define the amount the engaging part protrudes above the surface of the magnetic disk.

7. The magnetic disk apparatus as claimed in claim 6, further comprising:
another magnetic head; and
another retracting part corresponding to the other magnetic head, the other retracting part having another engaging part;
wherein the other retracting part includes another positioning part configured to define the amount the other engaging part protrudes above the surface of the magnetic disk.
